(19) United States
(12) Patent Application Publication
(10) Pub. No.: US 2016/0293225 A1
(43) Pub. Date: Oct. 6, 2016

(54) MODULAR STORAGE MEDIUM WITH INTEGRATED COOLING FOR ELECTRICAL DEVICES

(71) Applicant: THOMSON LICENSING, Issy-Ies-Moulineaux (FR)

(72) Inventor: Thomas Edward HORLANDER, Indianapolis, IN (US)

(21) Appl. No.: 15/037,811

(22) PCT Filed: Dec. 23, 2013
(86) PCT No.: PCT/US13/77417

§ 371 Date: May 19, 2016

(51) Int. Cl. G11B 33/14; G11B 33/02

(52) U.S. Cl. CPC G11B 33/142; G11B 33/027

(57) ABSTRACT

A modular digital storage medium and cooling assembly includes a digital storage medium positioned at one end of the modular digital storage medium and cooling assembly, and a fan spaced apart from the digital storage medium. The assembly inserts into an electronic device and provides digital data storage and cooling functions for the electronic device.

### TECHNICAL FIELD

The present invention generally relates to electronic devices that employ digital storage media and cooling mechanisms, and more particularly, to a modular storage medium with integrated cooling for such electronic devices.

### BACKGROUND

Electronic devices often employ digital storage media and cooling mechanisms. For example, certain digital set-top boxes may include digital video recorder (DVR) functionality that enables users to record selected digital content and play back such content at a later time, as desired. Such DVR functionality is often provided via a hard disk drive (HDD).

There is a growing trend in the digital video industry to produce products with DVR functionality which in fact do not include an HDD. These types of electronic devices or products may be referred to or described as “DVR-ready” or “DVR-lite” devices or products. There are a number of reasons for this product level approach. In some cases, a service provider may be anticipating a transition to a DVR “in the cloud” and wants to provide an easy path to eliminate the HDD from the product. In other cases, the service provider may be trying to avoid the capital equipment cost of the HDD, which is typically the single most expensive component in a DVR device, as well as one of the highest failure items.

One problem with creating DVR-ready products is that there is a significant power and thermal load presented on the overall product system by the addition of an HDD. In most cases, a non-DVR product can be designed to be completely passively cooled, e.g., without use of a cooling fan, which offers the benefit of reliability and low noise. However, in the case of a DVR with an HDD, it is almost always the case that forced cooling is required in order to ensure a thermal environment for the product that offers reliable operation over a reasonable product lifetime.

Today, when designing a DVR-ready product, all of the cooling provisions must be put in place at the beginning in order to anticipate the later addition of an HDD. However, this adds cost to the product that may not be required if the DVR feature is never used, i.e. no HDD is ever inserted or installed.

Accordingly, there is a need for an improved method and system to address the foregoing issues.

### SUMMARY OF THE INVENTION

One aspect of the present invention provides an electronic device, which comprises a housing operative to receive a modular digital storage medium and cooling assembly. The modular digital storage medium and cooling assembly comprises a digital storage medium positioned at one end of the modular digital storage medium and cooling assembly, and a fan spaced apart from the digital storage medium.

Another aspect of the present invention provides an assembly, which comprises a digital storage medium positioned at one end of the assembly, and a fan spaced apart from the digital storage medium. The assembly inserts into an electronic device and provides digital data storage and cooling functions for the electronic device.

Yet another aspect of the present invention provides a method, which comprises: providing an electronic device operative to receive a modular digital storage medium and cooling assembly, the modular digital storage medium and cooling assembly comprising a digital storage medium positioned at one end of the modular digital storage medium and cooling assembly, and a fan spaced apart from the digital storage medium; receiving the modular digital storage medium and cooling assembly by the electronic device; and operating the electronic device by using data from the digital storage medium and cooling the electronic device via the fan.

This summary of exemplary embodiments of the present invention is merely illustrative of the inventive concepts presented herein, and is not intended to limit the scope of the present invention in any manner.

### BRIEF DESCRIPTION OF THE DRAWINGS

The teachings of the present principles can be readily understood by considering the following detailed description in conjunction with the accompanying drawings, in which:

FIG. 1 shows a modular digital storage medium and cooling assembly according to exemplary embodiments of the present invention;

FIG. 2 shows an electronic device combined with a modular digital storage medium and cooling assembly according to exemplary embodiments of the present invention; and

FIG. 3 shows an electronic device combined with a modular digital storage medium and cooling assembly according to other exemplary embodiments of the present invention.

The examples set out herein illustrate preferred embodiments of the invention, and such examples are not to be construed as limiting the scope of the invention in any manner.

### DETAILED DESCRIPTION

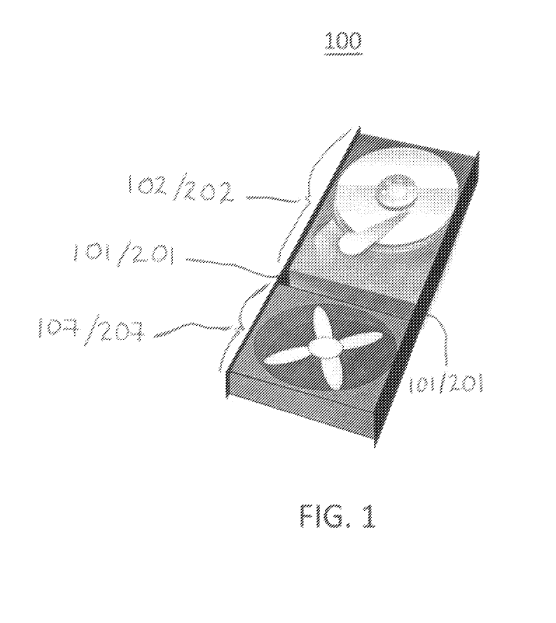

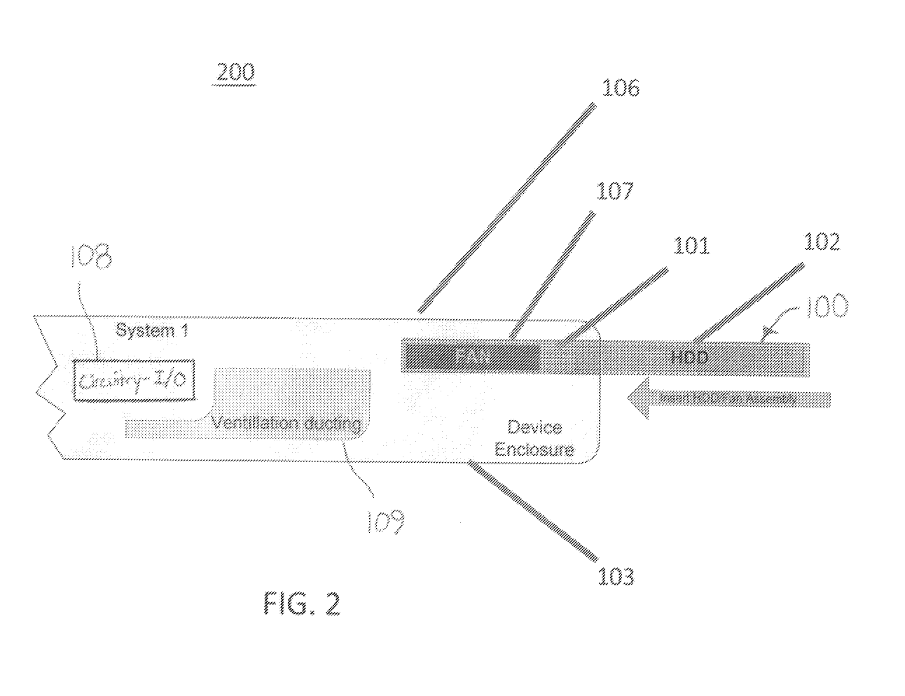

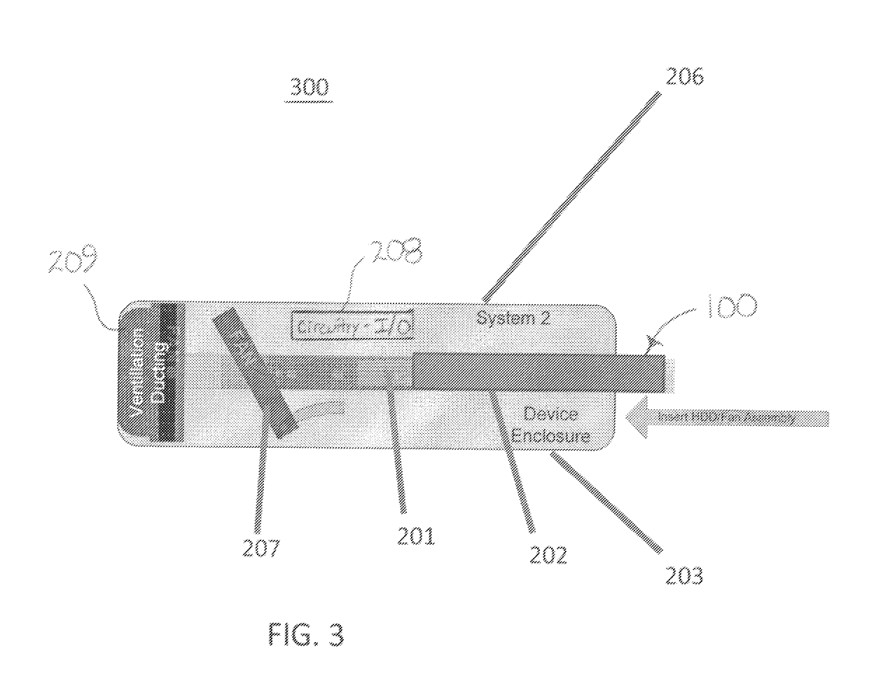

FIG. 1 shows a modular digital storage medium and cooling assembly 100 according to exemplary embodiments of the present principles. Modular digital storage medium and cooling assembly 100 of FIG. 1 is configured as an integrated unitary structure or carrier having two side walls 101/201 that may be parallel or angled relative to one another (sidewall 101 is also shown in a side view in FIG. 2, and sidewall 201 is also shown in a side view in FIG. 3). A digital storage medium 102/202, such as a hard disk drive (HDD) or other type of storage medium, is positioned between side walls 101/201 at one distal end of modular digital storage medium assembly 100. A fan 107/207 (and possibly other elements of a cooling system) is also positioned between side walls 101/201 and is spaced apart from digital storage medium 102/202, such as at the other distal end of modular digital storage medium assembly 100.

According to exemplary embodiments, digital storage medium 102/202 and fan 107/207 are aligned in the same plane, or in different planes, when modular digital storage medium and cooling assembly 100 is in a stand-alone position (i.e., prior to being installed within a compatible electronic device). For clarity of description, certain conventional elements and features associated with modular digital storage medium and cooling assembly 100, such as plugs, wires, cables and the like are not shown in the drawings.

According to principles of the present invention, modular digital storage medium and cooling assembly 100 of FIG. 1 is combined with (e.g., plugged or inserted into) a compatible (e.g., a DVR-ready, etc.) electronic device to advantageously provide an integrated source of digital data storage and active cooling for the electronic device without increasing the need for significantly more volume within the device housing. In this manner, digital storage medium 102/202 and fan 107/207 are combined onto a single module that can be inserted into an interior portion of an electronic device in a manner such that fan 107/207 not only cools digital storage medium 102/202, but also provides cooling for the entire product or device itself. This cooling capability of fan 107/207 advantageously accounts for the extra thermal load of digital storage medium 102/202, as well as the added power consumption in the overall system or device for the added DVR features (e.g., power conversion, extra stream processing, addition of transcoding, etc.) that results after modular digital storage medium and cooling assembly 100 is combined with a compatible electronic device, such as one shown in FIGS. 2-3 described below.

FIG. 2 shows an electronic device 200 operatively combined with a modular digital storage medium and cooling assembly 100 according to exemplary embodiments of the present invention. Electronic device 200 can be embodied as a DVR-ready product, such as a digital set-top box having digital data recording and playback functionality, but can also be embodied as any type of electronic device having digital data storage and active device cooling functions, with or without an integrated display device.

In one example, electronic device 200 comprises a housing or enclosure including a bottom base 103 and a top cover 106. Modular digital storage medium and cooling assembly 100 of FIG. 1 is combined with compatible electronic device 200 by being inserted into any type of compatible interface (e.g., opening, etc.) formed in the housing and placed to rest in a fixed position between top cover 106 and bottom base 103 during operation of electronic device 200. In one configuration, the fixed position is parallel to the top cover 106 and bottom base 103.

Any type of suitable interface, such as an external interface (e.g. USB, eSATA, among others), or a slot or opening into an interior portion of the product or device, can be used by electronic device 200 for receiving modular digital storage medium and cooling assembly 100. In the latter case, electronic device 200 may include rails, a specialized enclosure and/or other mechanical means (not expressly shown) to assist with the proper alignment and insertion of modular digital storage medium and cooling assembly 100 within its housing. In some embodiments, modular digital storage medium and cooling assembly 100 is completely enclosed within the housing of electronic device 200 when the former is combined with (i.e., inserted into) the latter, although this is not a requirement.

Electronic device 200 further comprises circuitry-input/output (I/O) block 108, which is configured or operative to provide various functions including signal processing (e.g., encoding, decoding, etc.), power, control, memory, and I/O functions which enable electronic device 200 to perform its operations, including digital data recording and playback operations. The circuitry portion of block 108 may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the circuitry portion of block 108 is implemented as a combination of hardware and software.

Moreover, the software may be implemented as an application program tangibly embodied on a program storage device of block 108. The application program may be uploaded to, and executed by, a machine of block 108 comprising any suitable architecture. Preferably, the machine is implemented on a computer platform having hardware such as one or more central processing units (CPU), a random access memory (RAM), and I/O interface(s). The computer platform also includes an operating system and microinstruction code. The various processes and functions provided by electronic device 200 may either be part of the microinstruction code or part of the application program (or a combination thereof), which is executed via the operating system.

The I/O portion of block 108 is operative to perform various I/O functions of electronic device 200, including receiving signals such as audio, video and/or data signals in analog and/or digital format from one or more signal sources such as terrestrial, cable, satellite, internet and/or other signal sources, and outputting signals to and receiving signals from one or more other devices. According to exemplary embodiments, circuitry-I/O block 108 is operatively coupled to modular digital storage medium and cooling assembly 100 when the latter is combined with (e.g., inserted into) electronic device 200. This coupling may be provided by any type of wired, wireless connector, plug mechanism, or combinations thereof, which enables electrical communication between circuitry-I/O block 108 and modular digital storage medium and cooling assembly 100. Circuitry-I/O block 108 can also be configured to provide operating power to modular digital storage medium and cooling assembly 100, and read and write digital data between itself and digital storage medium 102 when modular digital storage medium and cooling assembly 100 is combined with electronic device 200.

Electronic device 200 further comprises ventilation ducting 109, which enables passage of thermal energy or heat from an interior of the housing of electronic device 200 to an exterior of the housing of electronic device 200, e.g., through one or more grills or vents on the housing electronic device 200. Ventilation ducting 109 is preferably configured such that its boundaries interface, in an air-tight manner, with boundaries of fan 107 of modular digital storage medium and cooling assembly 100 when the latter is combined with or inserted into electronic device 200.

In the configuration shown in FIG. 2, fan 107 is positioned parallel to digital storage medium 102 and draws heat downwardly into an opening of ventilation ducting 109 which enables passage of the heat to an exterior portion of electronic device 200 (as indicated by the broken lines of the housing shown on the left side of FIG. 2). In this manner, fan 107 not only cools digital storage medium 102, but also advantageously provides cooling for the entire electronic device 200 itself (including block 108) and thereby takes into account the added power consumption in the overall system or device 200 for the added DVR features (e.g., power conversion, extra stream processing, addition of transcoding, etc.) that result after modular digital storage medium and cooling assembly 100 of FIG. 1 is combined with compatible electronic device 200 of FIG. 2.

FIG. 3 shows an electronic device 300 operatively combined with a modular digital storage medium and cooling assembly 100 according to other exemplary embodiments of the present invention. In one embodiment, electronic device 300 is embodied as a DVR-ready product, such as a digital set-top box having digital data recording and playback functionality, but can also be embodied as any type of electronic device having digital data storage and active device cooling functions, with or without an integrated display device.

In one example, electronic device 300 comprises a housing or enclosure including a bottom base 203 and a top cover 206. Modular digital storage medium and cooling assembly 100 of FIG. 1 is combined with compatible electronic device 300 by being inserted into any type of compatible interface (e.g., opening, etc.) formed in the housing and placed to rest in a fixed position between top cover 206 and bottom base 203 during operation of electronic device 300. In one configuration, the fixed position is parallel to the top cover 206 and bottom base 203.

Any type of suitable interface, such as an external interface (e.g. USB, eSATA, among others), or a slot or opening into an interior portion of the product or device, can be used by electronic device 300 for receiving modular digital storage medium and cooling assembly 100. In the latter case, electronic device 300 may include rails, a specialized enclosure and/or other mechanical means (not expressly shown) to assist with the proper alignment and insertion of modular digital storage medium and cooling assembly 100 within its housing. In some embodiments, modular digital storage medium and cooling assembly 100 is completely enclosed within the housing of electronic device 300 when the former is combined with or inserted into the latter, although this is not a requirement.

Electronic device 300 further comprises circuitry-input/output (I/O) block 208, which provides the same or similar functions as circuitry-I/O block 108 of FIG. 2, and ventilation ducting 209, which provides the same or similar functions as ventilation ducting 109 of FIG. 2. However, electronic device 300 differs from electronic device 200 in that the former provides a different configuration for fan 207 and ventilation ducting 209.

In the configuration of FIG. 3, fan 207 is inclined or perpendicular relative to digital storage medium 202 when modular digital storage medium and cooling assembly 100 is inserted into an interior of the housing of electronic device 300 and placed in its resting position between bottom base 203 and a top cover 206. According to exemplary embodiments, fan 207 rotates to a predetermined angular orientation different from an angular orientation of digital storage medium 202 in response to modular digital storage medium and cooling assembly 100 being inserted into the housing of electronic device 300. This rotation may be achieved, for example, via the shape of the interior housing of electronic device 300, which interacts with and places a rotational force upon fan 207 as modular digital storage medium and cooling assembly 100 is inserted into an interior of the housing of electronic device 300.

In this manner, fan 207 is placed in a predetermined position relative to ventilation ducting 209 to enable passage of thermal energy or heat from an interior of the housing of electronic device 300 to an exterior of the housing of electronic device 300 (e.g., through one or more grills or vents on the housing electronic device 300) when modular digital storage medium and cooling assembly 100 is inserted into the housing of electronic device 300.

Ventilation ducting 209 of FIG. 3 is also preferably configured such that its boundaries interface, in an air-tight manner, with boundaries of fan 207 of modular digital storage medium and cooling assembly 100 when the latter is combined with or inserted into electronic device 300. Fan 207 not only cools digital storage medium 202, but also advantageously provides cooling for the entire electronic device 300 itself (including block 208) and thereby takes into account the added power consumption in the overall system or device 300 for the added DVR features (e.g., power conversion, extra stream processing, addition of transcoding, etc.) that result after modular digital storage medium and cooling assembly 100 of FIG. 1 is combined with compatible electronic device 300 of FIG. 3.

As described above, embodiments of the present invention provide a modular storage medium with integrated cooling for electronic devices. While the forgoing is directed to various preferred configurations, other embodiments may be devised without departing from the basic scope thereof. Thus, the appropriate scope of the invention is to be determined according to the claims that follow.

1. An electronic device, comprising:
a housing operative to receive a modular digital storage medium and cooling assembly, said modular digital storage medium and cooling assembly comprising:
a digital storage medium positioned at one end of said modular digital storage medium and cooling assembly; and
a fan positioned spaced apart from said digital storage medium.

2. The electronic device of claim 1, wherein:
said modular digital storage medium and cooling assembly comprises two side walls;
said digital storage medium comprises a hard disk drive positioned between said side walls;
said housing includes a top cover and a bottom base; and
said modular digital storage medium and cooling assembly is inserted into an opening formed in said housing and rests in a fixed position between said top cover and said bottom base during operation of said electronic device.

3. The electronic device of claim 1, further comprising circuitry operatively coupled to said modular digital storage medium and cooling assembly when said modular digital storage medium and cooling assembly is inserted into said housing.

4. The electronic device of claim 3, wherein said circuitry provides operating power to said modular digital storage medium and cooling assembly.

5. The electronic device of claim 3, wherein said circuitry comprises a processor, a memory and a decoder.

6. The electronic device of claim 3, further comprising ventilation ducting for enabling passage of thermal energy generated by said modular digital storage medium and cooling assembly and said circuitry from an interior of said housing to an exterior of said housing when said modular digital storage medium and cooling assembly is inserted into said housing.

7. The electronic device of claim 1, further comprising ventilation ducting for enabling passage of thermal energy from an interior of said housing to an exterior of said housing, and wherein said fan is located in a predetermined position relative to said ventilation ducting to enable said passage when said modular digital storage medium and cooling assembly is inserted into said housing.

8. The electronic device of claim 7, wherein:
said fan rotates to a predetermined angular orientation different from an angular orientation of said digital storage medium in response to said modular digital storage medium and cooling assembly being inserted into said housing; and
said fan is located in said predetermined position relative to said ventilation ducting when rotated to said predetermined angular orientation.

9. An assembly, comprising:
a digital storage medium positioned at one end of said assembly; and
a fan spaced apart from said digital storage medium; and
wherein said assembly inserts into an electronic device and provides digital data storage and cooling functions for said electronic device.

10. The assembly of claim 9, wherein said digital storage medium comprises a hard disk drive.

11. The assembly of claim 9, wherein:
said assembly comprises two side walls;
said assembly is inserted into an opening formed in a housing of said electronic device and rests in a fixed position between a top cover and a bottom base of said electronic device during operation of said electronic device; and
said assembly is operatively coupled to circuitry of said electronic device during said operation of said electronic device.

12. The assembly of claim 11, wherein:
said assembly receives operating power from said circuitry; and
said circuitry comprises a processor, a memory and a decoder.

13. The assembly of claim 9, wherein:
said fan rotates to a predetermined angular orientation different from an angular orientation of said digital storage medium in response to said assembly being inserted into said electronic device; and
said fan is located in a predetermined position relative to ventilation ducting of said electronic device when rotated to said predetermined angular orientation.

14. A method, comprising:
providing an electronic device operative to receive a modular digital storage medium and cooling assembly, said modular digital storage medium and cooling assembly comprising a digital storage medium positioned at one end of said modular digital storage medium and cooling assembly and a fan spaced apart from said digital storage medium;
receiving said modular digital storage medium and cooling assembly by a housing of said electronic device; and
operating said electronic device by using data from said digital storage medium and cooling said electronic device via said fan.

15. The method of claim 14, wherein:
said modular digital storage medium and cooling assembly comprises side walls;
said digital storage medium comprises a hard disk drive positioned between said side walls;
said housing includes a top cover and a bottom base; and
said modular digital storage medium and cooling assembly is inserted into an opening formed in said housing and rests in a fixed position between said top cover and said bottom base during operation of said electronic device.

16. The method of claim 14, wherein circuitry of said electronic device is operatively coupled to said modular digital storage medium and cooling assembly in response to said modular digital storage medium and cooling assembly being received by said housing.

17. The method of claim 16, further comprised of said circuitry providing operating power to said modular digital storage medium and cooling assembly.

18. The method of claim 14, further comprised of enabling passage of thermal energy generated by said modular digital storage medium and cooling assembly and circuitry of said electronic device from an interior of said housing to an exterior of said housing when said modular digital storage medium and cooling assembly is received by said housing.

19. The method of claim 14, further comprised of enabling passage of thermal energy from an interior of said housing to an exterior of said housing, and wherein said fan is located in a predetermined position relative to ventilation ducting of said electronic device to enable said passage when said modular digital storage medium and cooling assembly is received by said housing.

20. The method of claim 19, further comprised of rotating said fan to a predetermined angular orientation different from an angular orientation of said digital storage medium in response to said modular digital storage medium and cooling assembly being inserted into said housing, and wherein said fan is located in said predetermined position relative to said ventilation ducting when rotated to said predetermined angular orientation.
